(19) United States
(12) Patent Application Publication
(10) Pub. No.: US 2016/0145485 A1
(43) Pub. Date: May 26, 2016

(54) DEGRADABLE MATERIAL FOR DOWNHOLE APPLICATIONS

(71) Applicants: James Doane, Friendswood, TX (US); Wayne Furlan, Cypress, TX (US); Ping Duan, Cypress, TX (US); Sayantan Roy, Houston, TX (US); Anil Sadana, Houston, TX (US)

(72) Inventors: James Doane, Friendswood, TX (US); Wayne Furlan, Cypress, TX (US); Ping Duan, Cypress, TX (US); Sayantan Roy, Houston, TX (US); Anil Sadana, Houston, TX (US)

(73) Assignee: BAKER HUGHES INCORPORATED, Houston, TX (US)

(21) Appl. No.: 14/551,976

(22) Filed: Nov. 24, 2014

(51) Int. Cl. C09K 8/508; E21B 33/12

(52) U.S. Cl. CPC C09K 8/5086; E21B 33/12

(57) ABSTRACT

In one aspect, degradable material is disclosed, including: a polyurethane component with a first degradation rate in a downhole environment; and a corrosive additive component with a second degradation rate that is higher than a first degradation rate in the downhole environment. In another aspect, a method of temporarily sealing a downhole zone is disclosed, including: providing a polyurethane component with a first degradation rate in a downhole environment; providing a corrosive additive component with a second degradation rate that is higher than a first degradation rate in the downhole environment; mixing the polyurethane component and the corrosive additive component to form a degradable material; sealing the downhole zone with the degradable material; exposing the degradable material to the downhole environment; and degrading the degradable material.

### BACKGROUND

1. Field of the Disclosure

This disclosure relates generally to controllably degradable materials and systems that utilize same for downhole applications.

2. Background of the Art

Wellbores are drilled in subsurface formations for the production of hydrocarbons (oil and gas). Hydrocarbons are trapped in various traps or zones in the subsurface formations at different depths. In order to facilitate the production of oil and gas, it is often desired to utilize fracturing operations. During fracturing operations, downhole plugs and corresponding seals are utilized to isolate zones to prevent and limit fluid flow. Such plugs and corresponding seals must be removed or otherwise destroyed before production operations can begin. Such removal operations may be costly and/or time consuming. It is desired to provide a material that can provide a downhole seal while providing desired and predictable degradable characteristics over a wide range of temperatures for the desired time of operations and applications.

The disclosure herein provides controlled degradable materials and systems using the same to withstand down hole conditions.

### SUMMARY

In one aspect, a degradable material is disclosed, including: a polyurethane component with a first degradation rate in a downhole environment; and a corrosive additive component with a second degradation rate that is higher than a first degradation rate in the downhole environment.

In another aspect, a method of temporarily sealing a downhole zone is disclosed, including: providing a polyurethane component with a first degradation rate in a downhole environment; providing a corrosive additive component with a second degradation rate that is higher than a first degradation rate in the downhole environment; mixing the polyurethane component and the corrosive additive component to form a degradable material; sealing the downhole zone with the degradable material; exposing the degradable material to the downhole environment; and degrading the degradable material.

In another aspect, downhole system is disclosed, including: a casing string disposed in a wellbore; and a casing seal configured to seal against the casing string, including: a polyurethane component with a first degradation rate in a downhole environment; and a corrosive additive component with a second degradation rate that is higher than a first degradation rate in the downhole environment.

Examples of certain features of the apparatus and method disclosed herein are summarized rather broadly in order that the detailed description thereof that follows may be better understood. There are, of course, additional features of the apparatus and method disclosed hereinafter that will form the subject of the claims appended hereto.

### BRIEF DESCRIPTION OF THE DRAWINGS

The disclosure herein is best understood with reference to the accompanying figures, wherein like numerals have generally been assigned to like elements and in which:

FIG. 1 is a schematic diagram of an exemplary drilling system that includes downhole elements according to embodiments of the disclosure;

FIG. 2 is a schematic diagram of an exemplary frac plug for use in a downhole system, such as the one shown in FIG. 1, according to one embodiment of the disclosure;

FIG. 3 shows a view of an exemplary casing sealing member for use with the frac plug, such as the frac plug shown in FIG. 2 for use with a downhole system, according to one embodiment of the disclosure;

FIG. 3A shows a view of another embodiment of a casing sealing member for use with the frac plug, such as the frac plug shown in FIG. 2 for use with a downhole system, according to another embodiment of the disclosure;

FIG. 4A shows a chart representing the degradation characteristics of different polymeric resins at an exemplary downhole temperature;

FIG. 4B shows a chart representing the degradation characteristics of different polymeric resins at another exemplary downhole temperature;

FIG. 4C shows a chart representing the degradation characteristics of polymers with various corrosive filler at an exemplary downhole temperature; and

FIG. 4D shows a chart representing the degradation characteristics of polymers with various corrosive fillers at another exemplary downhole temperature.

### DESCRIPTION OF THE EMBODIMENTS

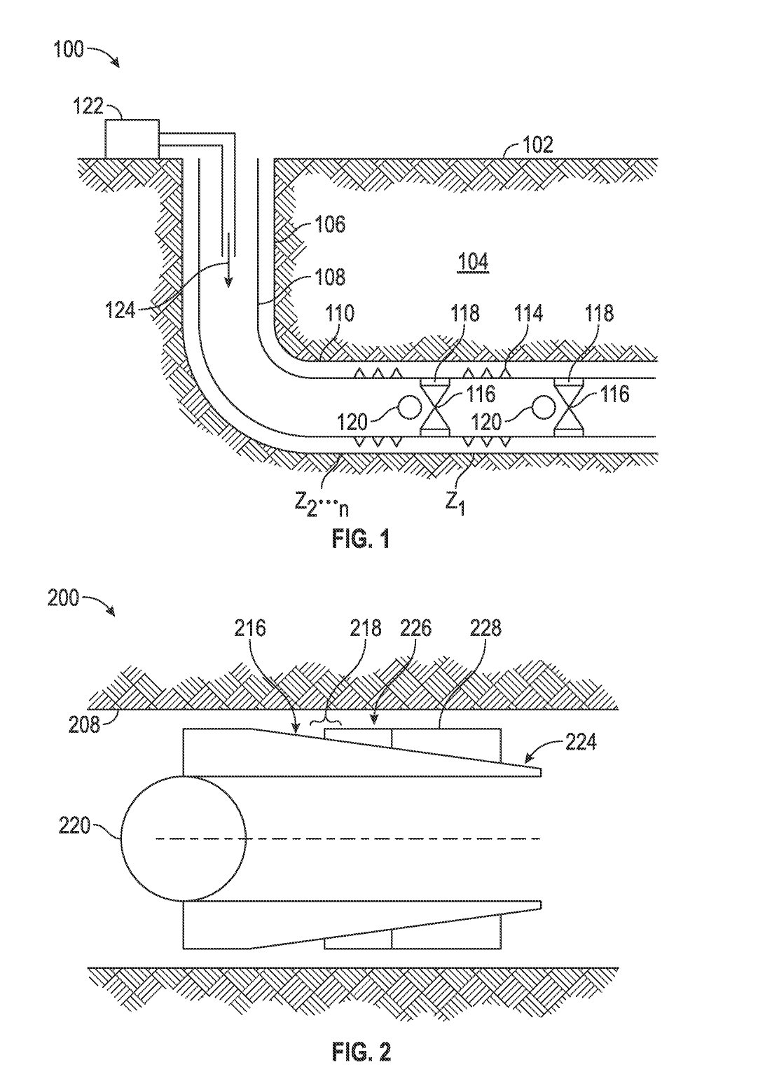

FIG. 1 shows an exemplary embodiment of a downhole system for fracturing (or fracing) operations to facilitate the production of oil and gas. System 100 includes a wellbore 106 formed in formation 104 with casing 108 disposed therein.

In an exemplary embodiment, a wellbore 106 is drilled from a surface 102 to a downhole location 110. Casing 108 may be disposed within wellbore 106 to facilitate production. In an exemplary embodiment, casing 108 is disposed through multiple zones of production Z1 . . . Zn in a downhole location 110. Wellbore 106 may be a vertical wellbore, a horizontal wellbore, a deviated wellbore or any other suitable type of wellbore or any combination thereof.

To facilitate fracturing operations, in an exemplary embodiment, frac plugs 116 are utilized within casing string 108. In certain embodiments, frac plugs 116 are utilized in conjunction with casing seals 118 and frac balls 120 to isolate zones Z1 . . . Zn for fracturing operations. In an exemplary embodiment, frac plugs 116 utilize casing seals 118 to seal plugs 116 against casing 108 of local zone 112 to prevent fluid flow therethrough. In certain embodiments, frac balls 120 are disposed at a downhole location 110 to obstruct and seal fluid flow in local zone 112 to facilitate flow to perforations 114.

In an exemplary embodiment, frac fluid 124 is pumped from a frac fluid source 122 to a downhole location 110 to flow through perforations 114 in a zone 112 isolated by frac plug 116 and frac ball 120. Advantageously, fracturing operations allow for more oil and gas available for production.

After fracturing operations, and before production operations, casing seals 118 are often removed or otherwise destroyed to allow the flow of oil and gas through casing 108. In an exemplary embodiment, casing seals 118 are configured to seal against casing 108 of local zone 112 until a predetermined time at which casing seals 118 dissolve to facilitate the production of oil and gas. In various applications, downhole conditions may vary, causing degradation to occur at different rates. Advantageously, in an exemplary embodiment, the casing seals 118 herein are formed of two degradable materials to have predictable and adjustable degradation characteristics for various downhole temperature ranges.

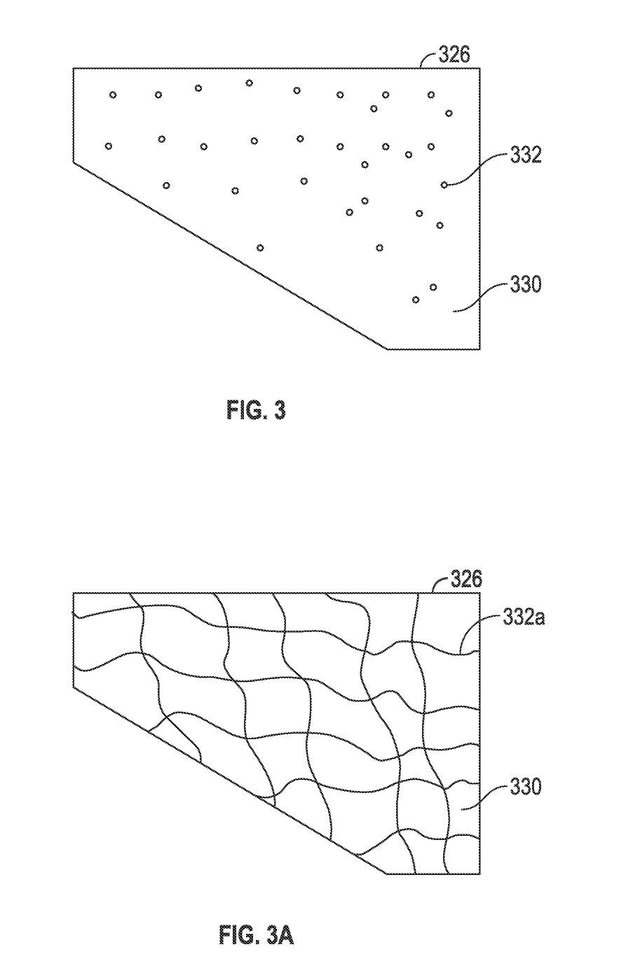

FIG. 2 shows a frac plug 216 for use downhole systems such as the system 100 shown in FIG. 1 for fracturing operations. In an exemplary embodiment, frac plug system 200 includes frac plug 216 interfacing with casing 208 via casing seal 218 and slip 228 to create a seal to isolate a zone for fracturing operations. In certain embodiments, frac plug 216 further receives frac ball 220 to isolate frac fluid flow.

In an exemplary embodiment, casing seal 218 includes a wedge 224 and a casing sealing member 226. In certain embodiments, wedge 224 is forced downhole to force casing sealing member 226 outward against casing 208 to seal against casing 208. In certain embodiments, wedge 224 is forced via a setting tool, explosives, or any other suitable means. In certain embodiments, frac plug 216 further utilizes a slip 228 to position frac plug 216 with respect to casing 208 and further resist movement. Slip 228 may similarly be driven toward casing 208 via wedge 224.

In an exemplary embodiment, casing sealing member 226 is formed of a degradable material. In an exemplary embodiment, the sealing member 226 is formed of two materials of different degradation rates for a given environment, to allow desired sealing characteristics while additionally allowing for the desired amount of degradation in varying downhole conditions. In downhole applications, downhole temperature may vary. In certain embodiments, the downhole temperature exposure to frac plug 216 varies from 100 to 350 degrees Fahrenheit at a particular downhole location for a given area. In certain embodiments, the temperature range of exposure may be larger or smaller. Typically, materials designed to degrade at a certain temperature may degrade too slowly or fail to degrade at a lower temperature, while at an elevated temperature, the material may degrade too quickly to perform desired functions. Advantageously, by utilizing casing sealing member 226 as described herein, a single frac plug 226 design may be utilized for various wells and well applications with a wide range of downhole temperatures, reducing costs and time compared to conventional solutions that may require a specially designed frac plug for a narrow temperature range.

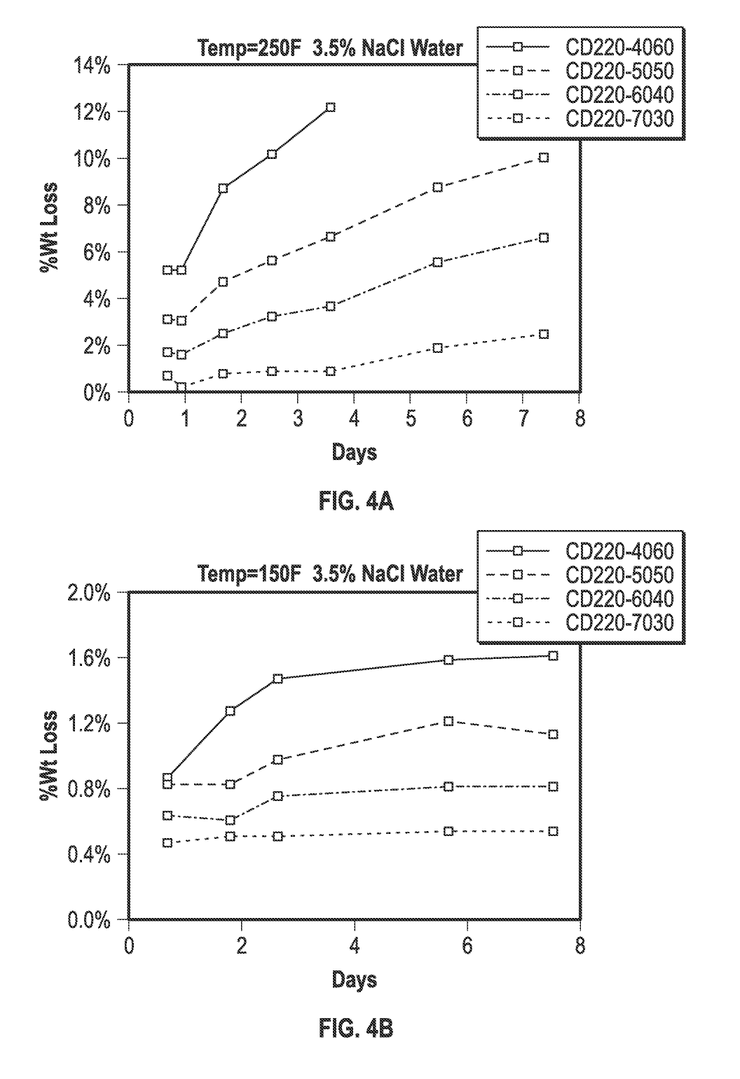

FIG. 3 shows an exemplary embodiment of casing sealing member 326. In an exemplary embodiment, casing seal 326 includes a base material 330 and a secondary additive material 332. In an exemplary embodiment, secondary additive material 332 is dispersed through base material 330 homogenously.

In an exemplary embodiment, base material 330 is a polymeric material. In an exemplary embodiment, base material 330 has a degradation rate that is contingent on the temperature of the fluid or environment in the wellbore. The base material 330 can include a polymer formed with isocyanates and a di-amine. In certain embodiments, the base material can include a polymer that includes TDI, MDI, PPDI, Polyether, polyesther, polycaprolactone, and polycarbonates. The polymers may further include PC-PPDI, PC-MDI, PD-TDI, Ether-PPDI, Ether-MDI, Ether-TDI, Esther-PPDI, Ester-MDI, and Ester-TDI. In an exemplary embodiment, base material 330 can be chosen due to the sensitivity to downhole conditions, degradation characteristics, and sealing characteristics.

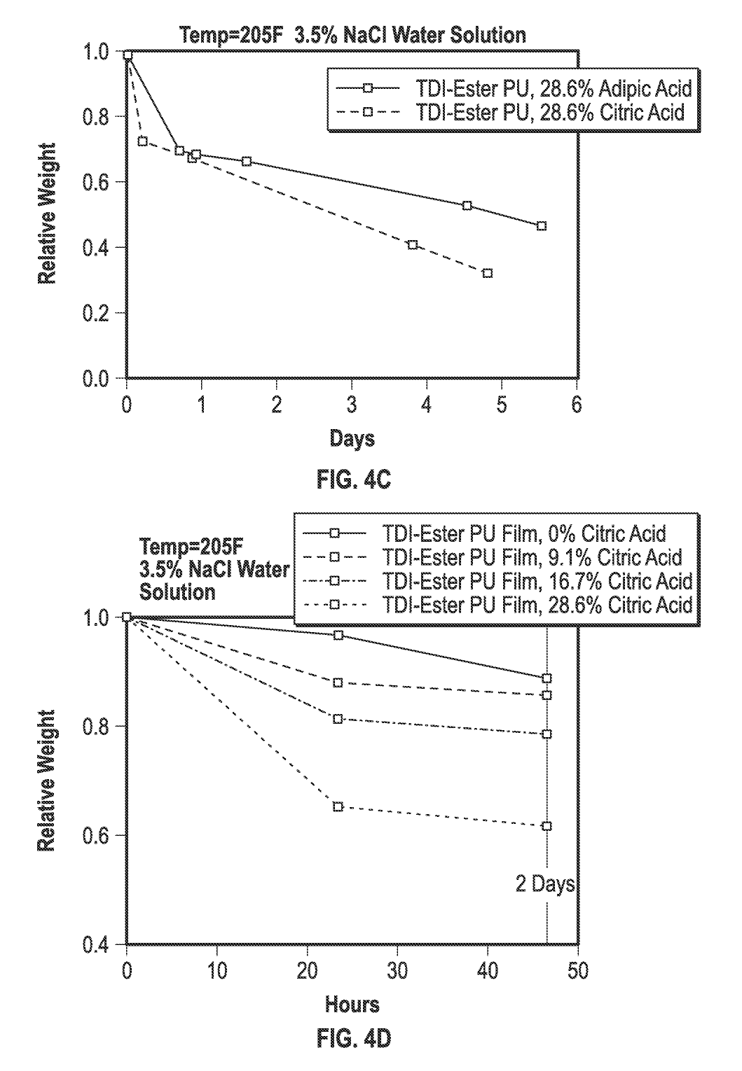

FIG. 4A shows a chart of degradation characteristics of various polymeric resins exposed to 3.5% salt water at an elevated temperature 250 F, to simulate downhole conditions. The degradation is shown as weight lost over time. Certain types of resins degrade fast than other types of resins. In the chart shown, a temperature representing a relatively high downhole As shown in FIG. 4A, the type of polyurethane formation selected affects the degradation rate of the overall material, as certain polymers, such as CD220-4060 degrades much faster than the other resins shown. Advantageously, a polymer can be selected based on degradation characteristics.

FIG. 4B shows various polymeric resins at a lower temperature (150 F), wherein the resins degrade at a lower rate. Similarly, different polymers exhibit different degradation rates. In certain embodiments, certain polymers, such as CD220-7030, exhibit minimal % weight loss are relatively low temperatures. Accordingly, certain polymers may not dissolve within operating parameters at lower temperatures.

In an exemplary embodiment, insert material 332 is mixed with base material 330 to form a material with a desirable degradation characteristic. In an exemplary embodiment, insert material 332 is a corrodible material, such as a corrodible metal. In certain embodiments, the corrodible metal is a controlled electrolytic metallic (CEM) material, including, but not limited to, Intallic. In certain embodiments, insert material 332 is a corrodible powder that is readily mixed with base material 330. In an exemplary embodiment, insert material 332 is a corrodible powder including, but not limited to adipic acid or citric acid.

FIG. 4C shows the effect of corrosive fillers and the relative faster degradation of an exemplary TDI-Ester polyurethane with corrosive fillers at 205 F. As shown by the chart, the addition of adipic acid or citric acid (at 28.6%) allows for a near linear degradation relationship over time. Accordingly, various corrosive fillers may be selected according to the desired degradation curve and time.

In certain embodiments, the relative amount of insert material 332 can be varied by weight or volume in relation to the base material 330. FIG. 4D shows the effect of various amounts of corrosive fillers (citric acid). As shown by the series of degradation curves, the addition of citric acid allows for a controlled increase in degradation. Utilizing this relationship can allow for a degradable material to be adapted to a downhole temperature range to allow for adequate sealing performance and desired degradation characteristics.

FIG. 3A shows an alternative embodiment of a casing seal 326. In an exemplary embodiment, casing seal 326 includes a base material 330 and a meshed or interlinked material 332a. The meshed or interlinked material 332a may be formed of the same or similar corrodible materials as described above, and may ensure complete or at least adequate degradation. Degradation may occur to break the casing seal 326 into small chunks to allow more surface area to be exposed for greater degradation.

Therefore in one aspect, a degradable material is disclosed, including: a polyurethane component with a first degradation rate in a downhole environment; and a corrosive additive component with a second degradation rate that is higher than a first degradation rate in the downhole environment. In certain embodiments, the downhole environment has a temperature greater than 100 degrees Fahrenheit and less than 350 degrees Fahrenheit. In certain embodiments, the downhole environment includes a salt water content. In certain embodiments, the polyurethane component and the corrosive additive component are homogenously mixed. In certain embodiments, the corrosive additive component is disposed in a mesh structure within the polyurethane component. In certain embodiments, the polyurethane component has a sealing characteristic. In certain embodiments, the polyurethane component includes: TDI, MDI, PPDI, polyether, polyesther, polycaprolactone, and polycarbonate. In certain embodiments, the corrosive additive component includes a controlled electrolytic metallic, adipic acid, and citric acid.

In another aspect, a method of temporarily sealing a downhole zone is disclosed, including: providing a polyurethane component with a first degradation rate in a downhole environment; providing a corrosive additive component with a second degradation rate that is higher than a first degradation rate in the downhole environment; mixing the polyurethane component and the corrosive additive component to form a degradable material; sealing the downhole zone with the degradable material; exposing the degradable material to the downhole environment; and degrading the degradable material. In certain embodiments, the downhole environment has a temperature of at least 100 degrees Fahrenheit and no greater than 350 degrees Fahrenheit. In certain embodiments, the downhole environment includes a salt water content. In certain embodiments, further including mixing the polyurethane component and the corrosive additive component homogenously. In certain embodiments, the corrosive additive component is disposed in a mesh structure within the polyurethane component. In certain embodiments, the polyurethane component has a sealing characteristic. In certain embodiments, the polyurethane component includes: TDI, MDI, PPDI, polyether, polyesther, polycaprolactone, and polycarbonate. In certain embodiments, the corrosive additive component includes a controlled electrolytic metallic, adipic acid, and citric acid.

In another aspect, a downhole system is disclosed, including: a casing string disposed in a wellbore; and a casing seal configured to seal against the casing string, including: a polyurethane component with a first degradation rate in a downhole environment; and a corrosive additive component with a second degradation rate that is higher than a first degradation rate in the downhole environment. In certain embodiments, the downhole environment has a temperature of at least 100 degrees Fahrenheit and no greater than 350 degrees Fahrenheit. In certain embodiments, the polyurethane component and the corrosive additive component are homogenously mixed. In certain embodiments, the corrosive additive component is disposed in a mesh structure within the polyurethane component.

The foregoing disclosure is directed to certain specific embodiments for ease of explanation. Various changes and modifications to such embodiments, however, will be apparent to those skilled in the art. It is intended that all such changes and modifications within the scope and spirit of the appended claims be embraced by the disclosure herein.

1. A degradable material, comprising:
a polyurethane component with a first degradation rate in a downhole environment; and
a corrosive additive component with a second degradation rate that is higher than a first degradation rate in the downhole environment.

2. The material of claim 1, wherein the downhole environment has a temperature greater than 100 degrees Fahrenheit and less than 350 degrees Fahrenheit.

3. The material of claim 1, wherein the downhole environment includes a salt water content.

4. The material of claim 1, wherein the polyurethane component and the corrosive additive component are homogenously mixed.

5. The material of claim 1, wherein the corrosive additive component is disposed in a mesh structure within the polyurethane component.

6. The material of claim 1, wherein the polyurethane component has a sealing characteristic.

7. The material of claim 1, wherein the polyurethane component includes: TDI, MDI, PPDI, polyether, polyesther, polycaprolactone, and polycarbonate.

8. The material of claim 1, wherein the corrosive additive component includes a controlled electrolytic metallic, adipic acid, and citric acid.

9. A method of temporarily sealing a downhole zone, comprising:
providing a polyurethane component with a first degradation rate in a downhole environment;
providing a corrosive additive component with a second degradation rate that is higher than a first degradation rate in the downhole environment;
mixing the polyurethane component and the corrosive additive component to form a degradable material;
sealing the downhole zone with the degradable material;
exposing the degradable material to the downhole environment; and
degrading the degradable material.

10. The method of claim 9, wherein the downhole environment has a temperature of at least 100 degrees Fahrenheit and no greater than 350 degrees Fahrenheit.

11. The method of claim 9, wherein the downhole environment includes a salt water content.

12. The method of claim 9, further comprising mixing the polyurethane component and the corrosive additive component homogenously.

13. The method of claim 9, wherein the corrosive additive component is disposed in a mesh structure within the polyurethane component.

14. The method of claim 9, wherein the polyurethane component has a sealing characteristic.

15. The method of claim 9, wherein the polyurethane component includes: TDI, MDI, PPDI, polyether, polyesther, polycaprolactone, and polycarbonate.

16. The method of claim 9, wherein the corrosive additive component includes a controlled electrolytic metallic, adipic acid, and citric acid.

17. A downhole system, comprising:
a casing string disposed in a wellbore; and
a casing seal configured to seal against the casing string, including:
a polyurethane component with a first degradation rate in a downhole environment; and
a corrosive additive component with a second degradation rate that is higher than a first degradation rate in the downhole environment.

18. The system of claim 17, wherein the downhole environment has a temperature of at least 100 degrees Fahrenheit and no greater than 350 degrees Fahrenheit.

19. The system of claim 17, wherein the polyurethane component and the corrosive additive component are homogenously mixed.

20. The system of claim 17, wherein the corrosive additive component is disposed in a mesh structure within the polyurethane component.
